(19) United States
(12) Patent Application Publication
(10) Pub. No.: US 2026/0363943 A1
(43) Pub. Date: Nov. 19, 2026

(54) MASSAGE DEVICE AND METHODS

(71) Applicant: Knobzz UK LTD., Pinner (GB)

(72) Inventor: Simeon NIEL-ASHER, Raanana (IL)

(73) Assignee: Knobzz UK LTD., Pinner (GB)

(21) Appl. No.: 19/477,870

(22) PCT Filed: Apr. 21, 2024
(86) PCT No.: PCT/IB2024/053877

§ 371 Date: Oct. 23, 2025

Related U.S. Application Data
(60) Provisional application No. 63/497,730, filed on Apr. 23, 2023.
(60) Provisional application No. 63/469,475, filed on May 29, 2023.
(60) Provisional application No. 63/606,119, filed on Dec. 5, 2023.

(51) Int. Cl. A61H 15/00; A61H 15/02; G01L 7/18

(52) U.S. Cl. CPC A61H 15/0078; A61H 15/02; A61H 2015/0064; A61H 2201/0192; A61H 2201/1671; A61H 2201/5071; G01L 7/18

(57) ABSTRACT

A massage device configured to selectively apply pressure at or near one or more target locations within a treatment area of a patient is provided. The device comprises a massage assembly comprising a massage head configured for selectively applying a pressure at or near the target locations, and a driving arrangement configured for moving the massage head about the treatment area; a pressure detection arrangement configured to detect pressure applied to the massage head; and a controller configured to direct operation of the massage device. The controller is further configured to identify one of the target locations where the pressure detection arrangement detects an elevated pressure applied to the massage head, and to direct the massage head to apply the pressure according to a predetermined pressure profile to the identified target location.

### TECHNOLOGICAL FIELD

The presently disclosed subject matter relates to patient treatment devices, and in particular to treatment devices configured to provide soft-tissue pressure treatment to a patient.

### SUMMARY

According to an aspect of the presently disclosed subject matter there is provided a massage device configured to selectively apply pressure at or near one or more target locations within a treatment area of a patient, the device comprising:
a massage assembly comprising:
   a massage head configured for selectively applying a pressure at or near the target locations; and
   a driving arrangement configured for moving the massage head about the treatment area;
a pressure detection arrangement configured to detect pressure applied to the massage head; and
a controller configured to direct operation of the massage device;
   the controller being further configured to:
identify a target location where the pressure detection arrangement detects an elevated pressure applied to the massage head; and
direct the massage head to apply the pressure according to a predetermined pressure profile to the identified target location.

The pressure detection arrangement may comprise a fluid bladder.

The fluid bladder may be disposed proximally to the massage assembly.

The fluid bladder may be filled with a gaseous medium.

The controller may be configured to direct the driving arrangement to move the massage head about the treatment area, and to identify a target location corresponding to the position of the massage head when the internal pressure of the air-pressure increases by a predetermined amount.

The pressure detection arrangement may comprise one or more pressure sensors disposed on the massage assembly.

The one or more pressure sensors may be disposed on the massage head.

The one or more pressure sensors may be configured to measure a force between the massage head and the driving arrangement.

The massage head may comprise two or more projections, each configured to apply a pressure at or near the target location.

The massage head may be configured to move the projections.

The massage head may be configured to rotate some or all of the projections about an axis.

The massage head may be configured to rotate the projections about a common axis.

The massage head may be configured to move the projections to change the lateral distance between them.

The massage head may be configured to move at least some of the projections along a distal-proximal axis independently of the other projections.

The massage head may be configured to move the projections while applying pressure.

The pressure profile may comprise a constant pressure for a predetermined amount of time.

The pressure profile may comprise a variable pressure for a predetermined amount of time.

The massage device may be further configured to apply photobiomodulation, ultrasound treatment, vibration, temperature treatment, transcutaneous electrical nerve stimulation, electrical muscle stimulation, and/or shockwave therapy to the patient.

The massage device may be configured to transmit usage information to an external system.

The massage device may be configured to receive information comprising treatment recommendations from an outside system.

According to another aspect of the presently disclosed subject matter, there is provided a massage head for use with a massage device, the massage head comprising two or more pressure arrangements, each pressure arrangement configured to selectively apply a pressure to a patient and detect a pressure applied thereto, the massage head further comprising a controller to direct its operation.

Each of the pressure arrangements may comprise a pressure tip assembly and a drive assembly, wherein the pressure tip assembly is configured to bear on the patient thereby applying a pressure and to detect a pressure applied thereto, and the drive assembly is configured to selectively move the pressure tip assembly toward or away from the patient along a longitudinal axis.

The drive assembly may comprise a motor unit and an extension unit, the motor unit being configured to operate the extension unit to cause an element thereof to move along the longitudinal axis, thereby moving the pressure tip assembly.

Rotation of the extension unit may cause the element to move along the longitudinal axis, the motor unit being configured to rotate the extension unit.

The pressure tip assembly may comprise a pressure carriage configured to be acted on by the drive assembly to be moved along the longitudinal axis, a pressure tip articulated to the pressure carriage such that it may move freely relative thereto along the longitudinal axis within a predefined range, and a pressure sensor configured to measure the pressure of the pressure tip bearing thereupon.

The pressure sensor may comprise a force-sensing resistor.

The massage head may further comprise a rotatable platform carrying the pressure arrangements, and a rotation assembly configured to selectively rotate the platform about a platform axis extending substantially perpendicularly through the platform.

The rotation assembly may be configured to rotate the platform to a predetermined angular position.

The rotation assembly may comprise a platform motor unit configured to effect the rotation of the platform, and a encoder assembly configured to facilitate determining and/or recording the angular position of the platform.

The rotation assembly may further comprise a homing sensor configured to facilitate determining the angular position of the platform.

The massage head may be further configured to apply photobiomodulation, ultrasound treatment, vibration, temperature treatment, transcutaneous electrical nerve stimulation, electrical muscle stimulation, and/or shockwave therapy to the patient.

The controller may be configured to determine that the orientation of the massage head is substantially parallel to the skin of the patient when substantially equal pressures are detected by each of the pressure arrangements.

The controller may be configured to triangulate locations of target locations on the patient.

According to another aspect of the presently disclosed subject matter, there is provided a massage device as above comprising one or more massage heads as above. It will be appreciated that according to this aspect as described and claimed, the controller of the massage device and the controllers of the massage heads may be provided as a single controller, and a massage device may be provided in which, e.g., features described herein with reference to the massage head's controller are carried out, in whole or in part, by the massage device's controller, mutatis mutandis.

According to another aspect of the presently disclosed subject matter, there is provided an apparatus configured to be secured to a patient and comprising a massage device as described above.

The apparatus may comprise a sleeve configured to be secured around the limb and/or the torso of a patient.

According to another aspect of the presently disclosed subject matter, there is provided an apparatus configured to be secured to an external article, the apparatus comprising a massage device as described above. The external article may be selected from a group consisting of a chair, a bed, a mattress, a sofa, a roller made compressed foam, a cushion, a pillow, a massage table, and a massage chair.

According to another aspect of the presently disclosed subject matter, there is provided a chair comprising a seat and a back, and further comprising a massage device as described above.

According to another aspect of the presently disclosed subject matter, there is provided a child safety seat comprising a massage device as described above.

According to another aspect of the presently disclosed subject matter, there is provided a method of administering a soft-tissue pressure treatment to a patient, the method comprising:
providing a massage device as described above;
detecting pressure applied to the massage head of the massage device at different locations within a treatment area of the patient;
identifying, by the massage device, of a target location within the treatment area wherein an elevated pressure is applied to the massage head; and
applying, by the massage head, a pressure according to a predetermined pressure profile to the identified target location, thereby administering the treatment.

The method may further comprise performing a pre-scan procedure prior to detecting pressure applied the massage head.

The pre-scan may comprise determining a baseline pressure for the treatment area.

The pre-scan may comprise constructing a pressure map of the treatment area.

The method may further comprise orienting the controller on the treatment area based on the pressure map.

The pre-scan may comprise scanning a sample of the treatment area to determine a predicted baseline pressure map for the treatment area.

The method may further comprise rotating the massage head about an axis.

The pressure profile may comprise a constant pressure for a predetermined amount of time.

The pressure profile may comprise a variable pressure for a predetermined amount of time.

The method may further comprise applying photobiomodulation, ultrasound treatment, vibration, temperature treatment, transcutaneous electrical nerve stimulation, electrical muscle stimulation, and/or shockwave therapy to the patient.

The method may further comprise transmitting usage information to an external system.

The method may further comprise receiving information comprising treatment recommendations from an outside system.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a perspective view of a massage device according to the presently disclosed subject matter;

FIG. 2 is a perspective view of an example of a massage head of the massage device according to the presently disclosed subject matter;

FIG. 3 illustrates another example of a massage head of the massage device according to the presently disclosed subject matter;

FIG. 4A is a perspective view of another example of a massage head according to the presently disclosed subject matter;

FIG. 4B is a perspective view of the massage head illustrated in FIG. 4A with a cover thereof removed;

FIG. 4C is a perspective view of a pressure arrangement of the massage head illustrated in FIG. 4A;

FIG. 4D is a perspective view of a drive assembly of the pressure arrangement illustrated in FIG. 4C;

FIG. 4E is a perspective view of an extension unit of the drive assembly illustrated in FIG. 4D;

FIG. 4F is a cross-sectional view of a pressure tip assembly of the pressure arrangement, taken along line IV-IV in FIG. 4C;

FIG. 4G is an exploded view of the pressure tip assembly illustrated in FIG. 4F;

FIG. 4H is a bottom perspective exploded view of a pressure carriage of the pressure tip assembly illustrated in FIG. 4F;

FIG. 4I is a bottom perspective view of the massage head illustrated in FIG. 4A with a cover and base thereof removed;

FIG. 4J is a bottom view of the massage head illustrated in FIG. 4A with a base thereof removed;

FIG. 5 illustrates a massage system according to the presently disclosed subject matter;

FIGS. 6A and 6B are examples of data presented on the computing device of the system illustrated in FIG. 5;

FIGS. 7A through 8 illustrate an area of pain experienced by a patient and a corresponding trigger point;

FIG. 9 illustrates a sleeve comprising the massage device according to the presently disclosed subject matter;

FIG. 10 illustrates a facemask comprising the massage device according to the presently disclosed subject matter;

FIG. 11 illustrates a glove comprising the massage device according to the presently disclosed subject matter;

FIG. 12 illustrates an apparatus configured to be secured to a chair and comprising the massage device according to the presently disclosed subject matter;

FIG. 13 illustrates a shoulder compression wrap comprising the massage device according to the presently disclosed subject matter;

FIGS. 14A and 14B illustrate a headrest and a neck pillow comprising the massage device according to the presently disclosed subject matter;

FIGS. 15A and 15B illustrate a wrist rest comprising the massage device according to the presently disclosed subject matter;

FIG. 16 illustrates a mat comprising the massage device according to the presently disclosed subject matter;

FIG. 17 illustrates a ball comprising the massage device according to the presently disclosed subject matter;

FIG. 18 illustrates examples of weighted objects comprising the massage device according to the presently disclosed subject matter; and

FIG. 19 illustrates a boot comprising the massage device according to the presently disclosed subject matter.

### DETAILED DESCRIPTION OF EMBODIMENTS

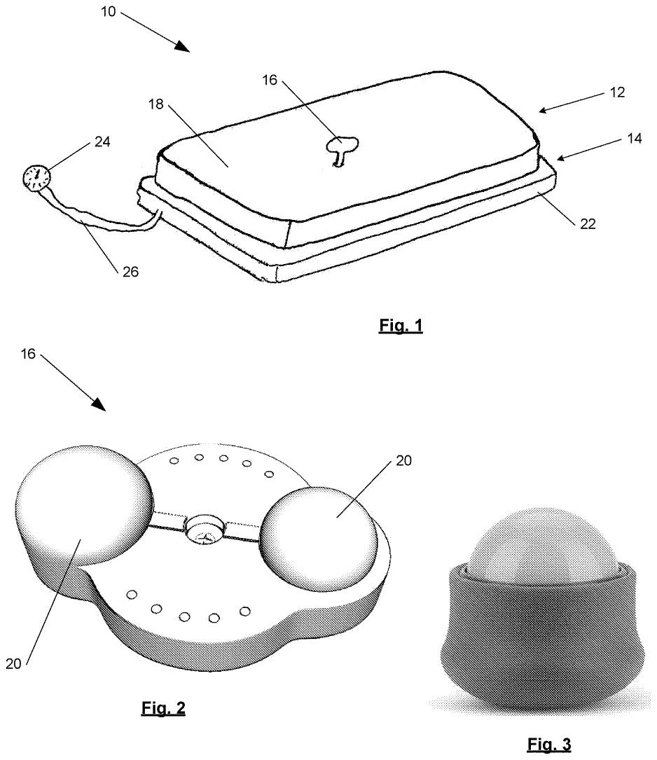

As illustrated in FIG. 1, there is provided a massage device, which is generally indicated at 10, for administering a treatment to a patient's muscles. In particular, the massage device 10 is configured to identify, within a treatment area of a patient, one or more target locations, potentially corresponding to a trigger point, for administering a treatment, the treatment comprising application of a localized pressure, e.g., by delivering a precise force, and to apply the localized pressure, for example according to a predetermined pressure profile, at the identified target locations.

It has been found that target locations, for example trigger points associated with pain experienced by the patient, may be characterized by an elevated pressure. Accordingly, the massage device 10 is configured to identify target locations by scanning the treatment area for locations of elevated pressure which indicate the presence of a target location. Identification of a target location is performed using the same element, e.g., a massage head or other element in contact with or directly bearing on the patient, which applies the pressure.

The massage device 10 comprises a massage assembly 12, configured to deliver a precise force thereby applying the localized pressure, and a pressure detection arrangement 14, configured to facilitate detection of localized elevated pressure. It further comprises a controller (not illustrated) configured to direct operation of the massage device 10.

It will be appreciated that while herein the specification and claims, the term “controller” is used with reference to a single element, it may comprise a combination of elements, which may or may not be in physical proximity to one another, without departing from the scope of the presently disclosed subject matter, mutatis mutandis. In addition, disclosure herein (including recitation in the appended claims) of a controller carrying out, being configured to carry out, or other similar/equivalent language, implicitly includes other elements of the massage device 10 carrying out, being configured to carry out, etc., those functions, without departing from the scope of the presently disclosed subject matter, mutatis mutandis.

The massage assembly 12 comprises a massage head 16 connected to a driving arrangement 18. The massage head 16 is configured to bear upon the patient, thereby applying a pressure at or near the target location, The massage head 16 is further configured to facilitate identification of a target location, as will be described below. According to some examples, the massage head comprises/constitutes a single projection for bearing on the patient. According to other examples, for example as illustrated in FIG. 2, it comprises two or more projections 20, each for bearing on the patient. According to examples in which the massage head 16 comprises two more or projections 20, the massage head may be configured to apply pressure to more than one location simultaneously. It will be appreciated that while the massage head 16 illustrated in FIG. 2 comprises two projections 20, the massage device 10 may comprise a massage head having any suitable number of projections, of similar or varying size, shape, etc.

The massage head 16 and projections 20 may be provided according to any suitable design. According to some examples, for example as illustrated in FIG. 3, the massage head 16 and/or projection 20 may comprise a ball bearing, e.g., configured as a pot or transfer bearing, for bearing on the patient.

The massage head 16 may be configured to rotate about an axis. According to some examples, the massage head 16 comprises a suitable mechanism for the rotation. According to other examples, the driving arrangement 18 is configured to rotate the massage head 16. According to examples in which the massage head 16 comprises two more or projections 20, the rotation may be about an axis located between the projections.

According to examples in which the massage head comprises two or more projections 20, the massage head may comprise an actuation arrangement (not illustrated), configured to move one or more of the projections on the massage head 16. According to some examples, the actuation arrangement is configured to change the lateral distance between two or more of the projections 20.

According to some examples, the actuation arrangement is configured to move one or more of the projections longitudinally, i.e., along a distal-proximal axis, independently of the other projections, thereby facilitating positioning some of the projections to project farther than do others. This may be useful, e.g., to vary the pressure exerted by the patient on different projections and vice versa, to compensate for contours of the treatment area, etc.

According to some examples, the massage device 10 comprises, for example on the massage head 16, one or more auxiliary treatment arrangements, configured to administer an additional treatment to the patient. The additional treatments may include, but are not limited to, photobiomodulation (i.e., low level laser therapy), ultrasound treatment, vibration, temperature (hot and/or cold) treatment, transcutaneous electrical nerve stimulation, electrical muscle stimulation, shockwave therapy, etc. Similarly, the massage head may be configured to provide haptic feedback to the patient.

The driving arrangement 18 is configured to move the massage head 16 laterally about, i.e., substantially parallel to a geometric surface approximating the treatment area. The driving arrangement 18, under direction of the controller, may be configured to move the massage head 16 such that it scans the treatment area, e.g., that it contacts most or substantially every location thereof, for example to search for target locations, to move the massage head 16 to a predefined location, e.g., a pre-identified target location, or to move for any other purpose.

The driving arrangement 18 may comprise any suitable mechanism (not illustrated) to effect the required movements. According to some examples, the mechanism comprises an XY-gantry, or any other suitable XY-linear actuator, mutatis mutandis.

As mentioned above, the pressure detection arrangement 14 is configured to facilitate detection of localized elevated pressure, and is disposed so as to measure a pressure exerted on the massage head 16.

Reverting to FIG. 1, the pressure detection arrangement 14 may comprise a flexible sealed fluid bladder 22 and one or more pressure sensors 24 configured to measure the internal pressure of the fluid bladder. The fluid bladder 22 may be filled with a gaseous medium, such as air, and/or it may be filled with a liquid medium, such as water. The pressure sensor 24 may be disposed on a measuring tube 26 in fluid communication with and projecting from the fluid bladder. The pressure sensor 24 is in communication with the controller to provide pressure readings thereto. The fluid bladder 22 may be disposed proximally to (i.e., closer to the patient than) the massage assembly 12, i.e., such that during use the massage assembly lies between the pressure detection arrangement 14 and the patient. When a pressure is exerted on the massage head 16, e.g., from contact with a location on the patient, the massage assembly 12 bears upon the fluid bladder 22 with corresponding force, raising its internal pressure, which is detected by the pressure sensor 24 and transmitted to the controller.

According to some examples, the fluid bladder 22 is disposed distally to the massage assembly 12, mutatis mutandis.

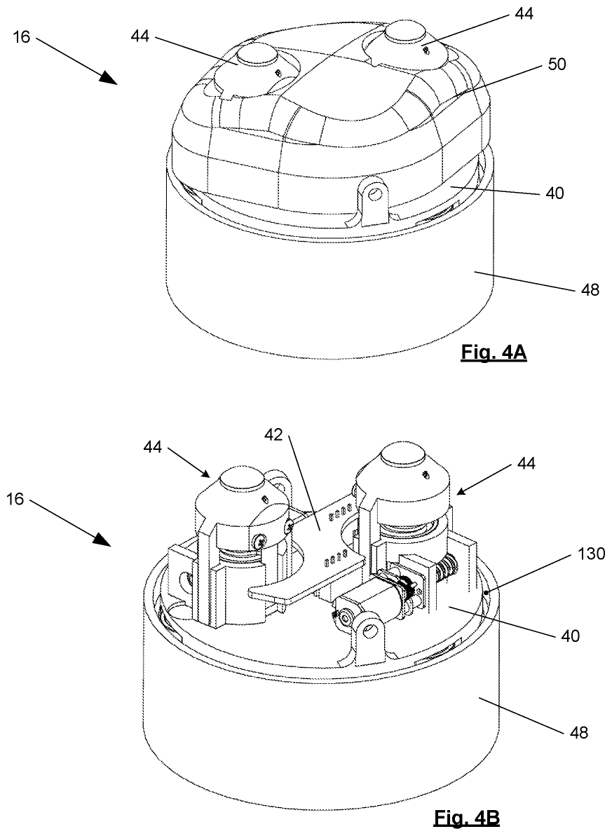

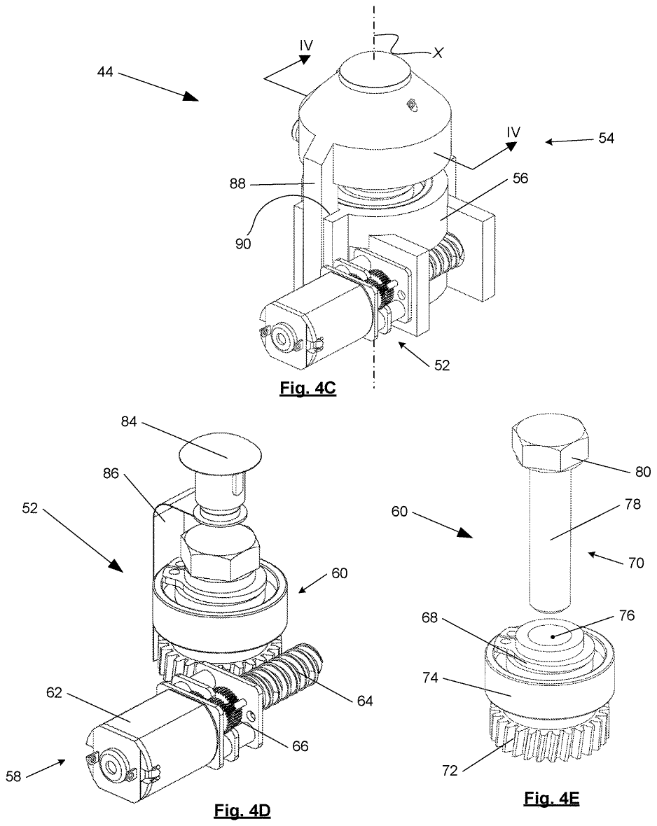

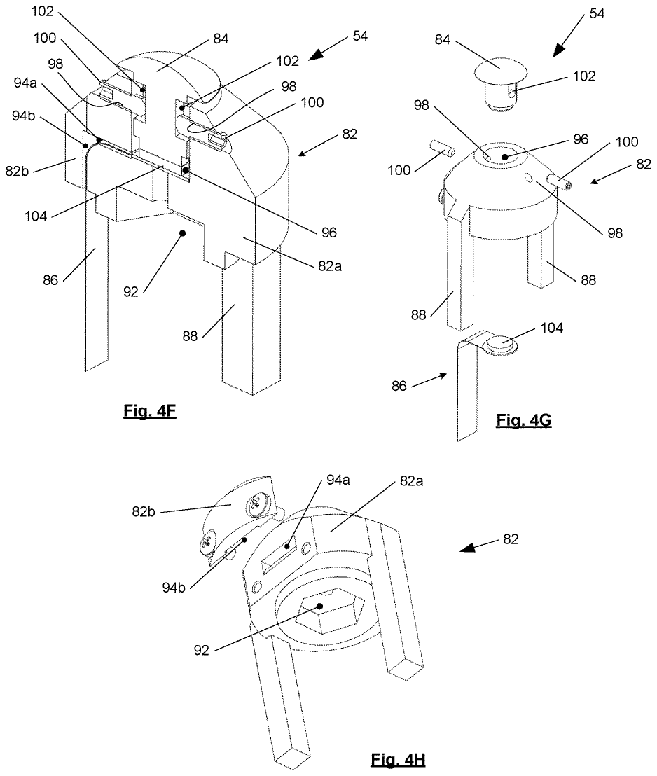

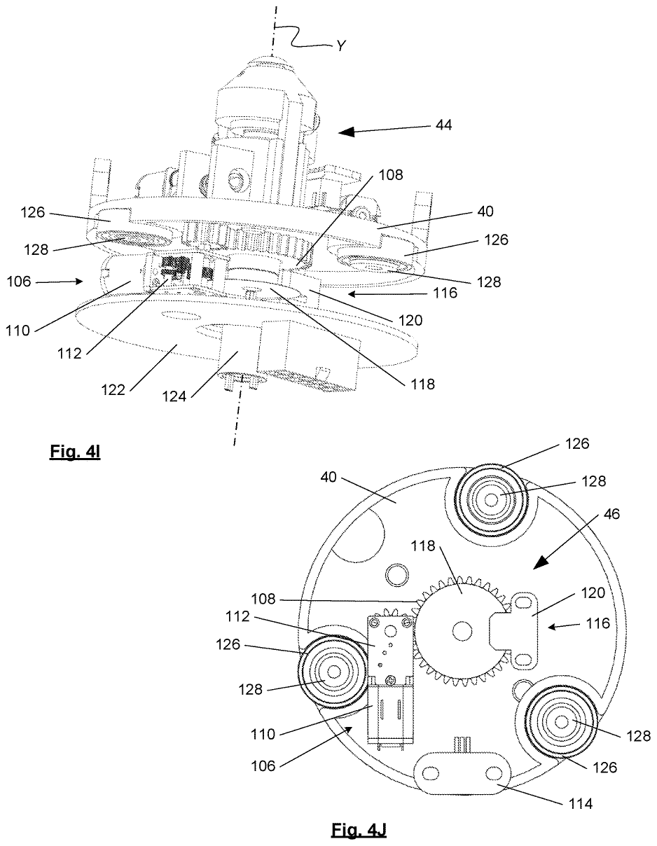

According to other examples, the pressure detection arrangement is integrated into the massage assembly 12. According to some examples, the massage device 10 comprises one or more pressure sensors, constituting the pressure detection arrangement, configured to measure pressure and transmit it to the controller. According to some examples, the pressure sensors are disposed on the massage head 16. According to some examples, the pressure sensors are configured to measure the force that the massage head 16 bears upon the driving arrangement 18. According to some examples, the pressure sensor measures pressure indirectly, for example being a strain gauge, in which the strain measured corresponds to a pressure on the massage head 16. As illustrated in FIGS. 4A and 4B, the massage head 16 according to some examples may comprise a platform 40 carrying a platform PCB assembly 42 and one or more pressure arrangements, each of which is generally indicated at 44. The massage head 16 further comprises a rotation assembly 46 (see FIGS. 4I and 4J; the rotation assembly 46 is not seen in FIGS. 4A and 4B), a base 48, and an optional cover 50.

As illustrated in FIG. 4C, the pressure arrangement 44 may comprise a drive assembly 52, a pressure tip assembly 54, and a pressure housing 56, and defines a longitudinal, i.e., extending in a distal-proximal direction, axis X. Operation of the pressure arrangement 44 may be effected by the massage device's 10 controller, which may be partially embodied by and/or in be communication with the platform PCB assembly 42.

The drive assembly 52 is configured to selectively provide motive power to the pressure tip assembly 54, thereby moving it distally and/or proximally relative to the rest of the massage head 16. Accordingly, as best seen in FIG. 4D (in which a pressure tip 84 and pressure sensor 86 of the pressure tip assembly 54 are shown for reference; these elements will be described below in more detail with reference to FIGS. 4F and 4G), it may comprise a motor unit 58 configured to operate an extension unit 60. The motor unit comprises a motor 62, such as a stepper motor or a servo motor, and a motor gear 64, e.g., a worm gear, configured to be rotated thereby. The motor gear 64 may be mounted on a shaft (not illustrated) which is rotatingly received within the pressure housing 56. According to some examples, the motor unit 58 may comprise a gear train 66, for example a speed reducer, between the motor 62 and the gear train 66.

According to some examples, as best seen in FIG. 4E, the extension unit 60 may comprise a drive tube 68 and a pushrod 70 operative to be linearly actuated by the drive tube. The drive tube 68 comprises a tube gear 72, e.g., a worm wheel, mounted to (including, but not limited to, being formed integrally with) an exterior surface thereof. A rolling-element bearing 74, for example a ball bearing, may be mounted to the exterior surface of the drive tube 68, such that the inner race is fixed in relation to the exterior surface of the drive tube, and the outer race is fixed in relation to an interior surface of the pressure housing 56, thereby facilitating rotation of the drive tube with respect to the pressure housing while restricting lateral movement thereof. The drive tube 68 further comprises a longitudinal bore 76, at least a portion of which is formed with internal threading. The internal threading may be formed integrally with the longitudinal bore 76, or be provided with a separate element, such as a threaded nut (not illustrated) secured within the drive tube 68 such that the threaded portion of the nut is aligned with the longitudinal bore 76.

The pushrod 70 comprises a threaded shaft 78 and a head 80 at the distal end of the threaded shaft. The pushrod 70 is received within the longitudinal bore 76 such that its threaded shaft 78 mates with the internal threading of the longitudinal bore. The head 80 of the pushrod 70 may have a non-circular cross-section (when taken perpendicular to the longitudinal axis X), which may be fixed so as to prevent rotation, for example as will be described below.

The motor unit 58 is configured to operate the extension unit 60 to linearly actuate the pushrod 70. For example, the motor gear 64 may be configured to cooperate with the tube gear 72 to rotate the drive tube 68 about the longitudinal axis X. When the drive tube 68 is rotated by the motor unit 58, the pushrod 70, which is constrained from rotating together therewith, is moved along the longitudinal axis X, either proximally or distally depending on the direction of rotation of the motor 62, as is well-known in the art.

The pressure tip assembly 54 is configured to facilitate detection of localized elevated pressure, and to facilitate application of a localized pressure to the patient. As illustrated in FIGS. 4F and 4G, it comprises a pressure carriage 82, a pressure tip 84, and a pressure sensor 86. In addition, the pressure tip assembly 54 is configured to selectively apply a pressure on the patient, by being moved toward the patient by the drive assembly 52, for example as described above.

The pressure carriage 82 is configured to move longitudinally along the longitudinal axis X. Accordingly, it may comprise one or more longitudinal guides 88, each configured to be slidingly received within a corresponding slot 90 formed in the pressure housing 56 (see, e.g., FIG. 4C), thereby facilitating the longitudinal movement of the pressure carriage. As best seen in FIG. 4H, a bottom surface of the pressure carriage 82 is formed with a socket 92 shaped so as to receive therein the head 80 of the pushrod 70, thereby fixing its position so as to prevent rotation thereof, for example when the drive tube 68 is rotated by the motor unit 58 as described above.

The pressure carriage 82 may be further formed with a channel 94 for receiving therewithin the pressure sensor 86. According to some examples, the pressure carriage 82 comprises a main portion 82a and a removable portion 82b attached thereto. (In the present disclosure, different elements indicated by a single reference numeral and distinguished by their trailing letters may be collectively indicated using the single reference numeral without a trailing letter, e.g., reference numeral 82 may be used to collectively indicate the main portion 82a and the removable portion 82b of the pressure carriage 82.) A first portion 94a of the channel 94 is formed in the main portion 82a of the pressure carriage 82, and the removable portion 82b is formed with a niche defining a second portion 94b of the channel 94.

The pressure carriage 82 further comprises a distal well 96, being formed as a blind aperture open in the distal direction, for receipt therein of the pressure tip 84. The proximal end of the well 96 may be open to one end of the channel 94. Two lateral bores 98 are formed, each opening into the sidewall of the well 96 and provided with a limiting pin 100 therewithin. The limiting pins 100 are each received within a corresponding notch 102 formed in the side of the pressure tip 84, thereby articulating the pressure tip to the pressure carriage 82 such that it may move freely along the longitudinal axis X, and limiting its longitudinal motion within the well 96.

According to some examples, the pressure sensor 86 comprises a force-sensing resistor. A sensing surface thereof 104, e.g., comprising a conductive polymer, is provided on a portion of the pressure sensor 86 which projects from the channel 94, such that the sensing surface 104 is disposed on a proximal surface of the well 96. Accordingly, the sensing surface 104 is positioned so as to sense the pressure exerted on the pressure tip 84.

The rotation assembly 46 is configured to facilitate rotation of the platform 40 about a distal-proximal (i.e., parallel to the longitudinal axis X defined by the pressure arrangement 44, and substantially perpendicular to the platform) platform axis Y. In particular, it may be configured to rotate the platform 40 to a predetermined angular position. Accordingly, as illustrated in FIGS. 4I and 4J, the rotation assembly 46 may comprise a platform motor unit 106 configured to rotate a platform gear 108 rigidly connected to, e.g., being formed with otherwise configured to rotate with, the platform 40. The motor unit 106 comprises a motor 110, such as a stepper motor or a servo motor, and may optionally comprise a gear train 112, for example a speed reducer, between the motor 110 and the platform gear 108. As best seen in FIG. 4J, the rotation assembly 46 may further comprise a homing sensor 114, for example comprising a Hall effect sensor, configured to facilitate determining the position of the motor 110.

An encoder assembly 116, for example a rotary encoder comprising an encoder disk 118 and encoder sensor 120, may be provided to determine the angular position of the platform 40. According to some examples, the encoder assembly 116 is an absolute encoder. The resolution of the encoder assembly 116 may be 1°, 0.5°, 0.25°(360, 720, and 1,440 points of rotation, respectively), or any other suitable resolution.

Operation of the rotation assembly 46 may be effected by the massage device's 10 controller, which may be partially embodied by and/or be in communication with a massage head PCB assembly 122. In addition, a slip ring 124 may be provided, to facilitate electrical and/or electronic connection to elements of the massage head 16 while the platform 40 rotates, while other elements, e.g., the massage head PCB assembly 122, remain motionless relative thereto.

The platform 40 may comprise a positioning arrangement configured to maintain the radial position of the platform while it rotates. According to some examples, the positioning arrangement comprises a plurality of rolling-element bearings 126, for example ball bearings, mounted to projections 128 formed on the platform. The bearings 126 may be mounted such that the inner race of each is fixed in relation to the platform, and the outer race is allowed to rotate relative thereto. The bearings 126 project slightly beyond an outer perimeter of the platform 40 and are received within a corresponding raceway 130 formed in the base 48 (see, e. g, FIG. 4B). The bearings 126 may be mounted on a lower (i.e., proximal) surface of the platform 40, e.g., as illustrated; accordingly, when the pressure arrangements 44 are operated to apply pressure to a patient, the bearings 126 are biased into the raceway 130.

It will be appreciated that while the massage head 16 described herein with reference to and as illustrated in FIGS. 4A through 4J comprises two pressure arrangements 44, in practice it may comprise one, three, or more pressure arrangements 44 without departing from the scope of the presently disclosed subject matter, mutatis mutandis. Moreover, descriptions herein of “the pressure arrangement” should be understood as referring to each of the pressure arrangements, unless otherwise clear, implicitly or explicitly, from context.

It will be further appreciated that, where relevant, the massage head 16 described above with reference to and illustrated in FIGS. 4A through 4J may be provided, mutatis mutandis, as per one or more of the examples described in connection with other examples of massage heads (i.e., as described above with reference to and illustrated in FIGS. 1 through 3), e.g., the massage head described with reference to and illustrated in FIGS. 4A through 4J may comprise an actuation arrangement, one or more auxiliary treatment arrangements, etc.

It will be further appreciated that the massage head 16 described above with reference to and illustrated in FIGS. 4A through 4J may be provided separate from the massage device 10 described herein, for example configured for use with a massage device not as described herein, configured for use with a different type of device, i.e., not for administering a treatment to a patient's muscles, as a standalone unit, etc., mutatis mutandis. Accordingly,

In use, the massage head 16 described with reference to and illustrated in FIGS. 4A through 4J may be configured to facilitate determining when it is oriented substantially parallel to the skin of the patient. In particular, according to examples in which the massage head 16 comprises two or more pressure arrangements 44, such an orientation may be determined when the pressure sensors of both pressure arrangements 44 detect substantially equal pressures. According to some examples, this may be done while the platform 40 is rotating.

In addition to determining orientation of the massage head 16, providing two or more pressure arrangements 44 may facilitate triangulation, e.g., to identify the locations of target locations, etc. This may be useful, for example, for constructing a pressure map, locating a pressure arrangement 44 at a trigger point, etc. According to some examples, this may be accomplished by other suitable means, for example using a feedback sensor arrangement based on, e.g., sound waves (such as ultrasound), light (such as lasers), additional pressure sensors, etc.

It will be appreciated that herein the specification and appended claims, descriptions of pressure detection and/or measurement may be indirect. For example, a pressure sense may be configured to measure a force which can be used to determine a pressure. Descriptions herein of pressure detection, measurement, etc., include such elements, mutatis mutandis.

During use, the controller directs the driving arrangement 18 to move the massage head 16 about the treatment area of the patient to scan for target locations, e.g., corresponding to locations of taut bands of soft tissue. The scanning may comprise directing the massage head 16 to apply a predetermined pressure on the patient. The controller is configured to monitor the pressure measurements transmitted by the pressure detection arrangement 14, for example as described above, while the massage head 16 is scanning, thereby facilitating detection of localized elevated pressure. In particular, the controller may be configured to identify a target location of the patient where the pressure detection arrangement detects an elevated pressure.

According to some examples, the scanning comprises a pre-scan procedure, in which the massage head 16 scans the entire treatment area or a significant sample thereof, i.e., sufficient to determine a baseline pressure for the treatment area. According to some examples, the pressure applied by the massage head 16 during the pre-scan is lower than that applied during the scanning.

Performing such a pre-scan may be useful, e.g., to compensate for the variance in levels of the pressure between the massage head 16 and the patient's body which may arise owing to external factors such as how tightly the massage device 10 is secured, etc.

According to some examples, the controller may use pressure data collected during the pre-scan to construct a pressure map of the treatment area. This may be used, e.g., to orient the controller on the treatment area, e.g., based on data from other pressure maps constructed on treatment areas on the corresponding area of the body on other patients, for example based on the expected variance in pressure over the treatment area based on its shape and/or anatomical structure. The controller may be configured, in particular according to examples in which the pre-scan comprises the massage head 16 scanning a sample of the treatment area, to determine a predicted baseline pressure map for the treatment area, for example to facilitate determining whether an elevated pressure detected at a point within the treatment area is expected, or if it indicates a target location.

It will be appreciated that a detected pressure may be considered “elevated” to associate it with a target location if it exceeds one or more reference pressures. A reference pressure may be determined in any suitable value. According to some examples, a reference pressure is determined based on one or more pressures measured at other locations in the treatment area. According to some examples, a reference pressure is determined based on a predetermined expected value for the pressure at the location, e.g., based on the contours of the treatment area, for example as described above.

According to some examples, a detected pressure is considered “elevated” if it exceeds the one or more reference pressures by a predetermined amount.

It will be further appreciated that minor elevations in pressure may be expected, and large elevations in pressure may be due to something other than a trigger point (e.g., the pressure detection arrangement may detect a pressure which is elevated by relatively large amount when the massage head 16 exerts pressure on protruding hard tissue, such as a shoulder blade). Accordingly, the controller may be configured to identify a target location where the pressure detection arrangement detects a pressure which is elevated by an amount which falls within a predetermined range. According to some examples, the range may be closed, i.e., a detected pressure must be elevated by an amount which exceeds a minimum value but does not exceed a maximum value in order to indicate a target location. According to other examples, the range is open-ended, i.e., it defines either a minimum amount or a maximum amount by which a detected pressure must be elevated in order to indicate a target location. The minimum and/or maximum values of the range may differ based on the location of the treatment area (e.g., based on its anatomy, based on historical data, etc.), based on information about the patient (e.g., weight, height, gender, user history, etc.), or on any other suitable factors.

According to some examples, the controller may be configured to direct the massage head 16 to move away from an identified target location, and to subsequently return to it to verify, prior to administering a treatment, whether or not the measured pressure is elevated.

The massage head 16 may rotate during scanning, e.g., such that the point of contact (or points of contact, for example according to examples described above in which the massage head 16 comprises two more or projections 20) between the massage head and the patient circles the axis of rotation. Accordingly, the target location may be identified as an area within the treatment area within which an elevated pressure was detected. According to some examples, the controlled may be configured to adjust the lateral distance between projections 20 while scanning, thereby identifying, in addition to a target location, but the size of a target location, for example based on the detected pressures at different lateral distances between the projections.

According to some examples, the controller directs the driving arrangement 18 to move the massage head 16 to scan the entire treatment area, and then to administer a treatment at a selected one or more of any identified target locations. According to other examples, the controller directs the driving arrangement 18 to move the massage head 16 to scan the treatment area, and to administer a treatment at a target location when it is identified.

As mentioned above, administering the treatment comprises applying a localized pressure, e.g., according to a predetermined pressure profile, at the target location. The localized pressure is applied by the massage head 16, which was also used to facilitate identifying the target location.

The pressure may be applied by any suitable method. According to some examples, the pressure within the fluid bladder may be increased, e.g., by constricting it at one or more locations, thereby causing the massage head 16 to apply a distally directed force on the patient. Accordingly, the pressure detection arrangement 14, per this example the fluid bladder 22 thereof, may be used to facilitate both identification of a target location and administering treatment by application the localized pressure.

According to some examples, for example wherein the massage head 16 comprises two or more projections 20, the massage head rotates (e.g., spirals) during administration of the treatment. According to some examples, the lateral distance between projections 20 is varied during administration of the treatment.

As mentioned above, application of the localized pressure may be performed according to a predetermined pressure profile. According to some examples, the pressure profile may define how the pressure changes over the course of the treatment and/or the length of the treatment. For example, it may define a pressure which varies according to a sinusoidal waveform, an “attack, sustain, decay” pattern (i.e., gradually increasing pressure over a first time period until it reaches a target pressure, maintaining the pressure over a second time period, and gradually decreasing the pressure over a third time period), and/or any other suitable method and/or combination of methods. For example, the pressure profile may comprise varying the pressure according to a sinusoidal waveform followed by an “attack, sustain, decay” pattern.

The length of each treatment may be any suitable amount of time, for example between 30 and 150 seconds. According to some examples, the length of a treatment is approximately 90 seconds.

The controller may be configured to apply pressure to the patient in areas besides the target location. According to some examples, it may operate the massage assembly 12 to perform a deep stroking massage, e.g., application of pressure while moving the massage head 16 generally along the direction of muscle fibers and surrounding myofascia, and/or any other suitable method.

As illustrated in FIG. 5, a massage system, which is generally indicated at 200, may be provided. According to some examples, the massage system may be configured to facilitate a user (i.e., a patient) to administer a treatment to himself, e.g., without direct involvement of a professional. The massage system 200 may comprise a massage device 210 similar to that described above with reference to and as illustrated in FIGS. 1-3, and a computing device 250. The computing device 250 may be a dedicated device, or it may be implemented as software installed on a general-purpose computer, for example as an application running on a smartphone, tablet, etc.

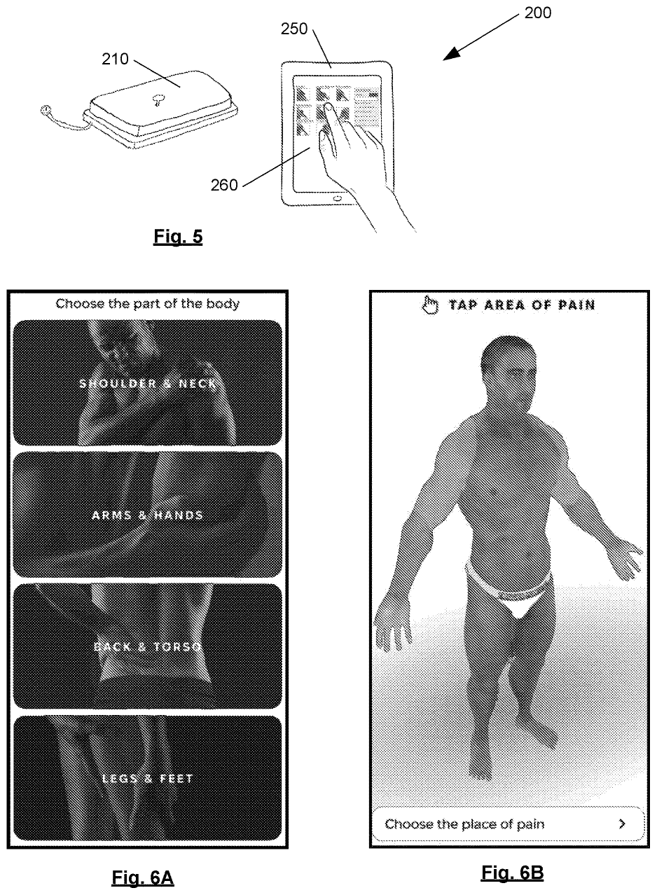

The computing device 250 may comprise a user interface 260, on which it prompts the patient to indicate the area where they are experiencing pain. The user interface may be a touchscreen, thereby receiving input and displaying output on a single interface. As illustrated in FIGS. 6A and 6B, the computing device 250 may be configured to present several general anatomical areas (e.g., back of arm, front of shoulder, mid-thoracic back, etc.) and/or specific areas (e.g., deltoid, levator scapulae). These areas may be accompanied by figures illustrating the areas to aid in patient selection. Once the area in which pain is experienced is indicated, the computing device 250 determines a corresponding trigger point to which a treatment may be applied to address the pain in the indicated area. A database of anatomical areas and corresponding trigger points may be stored in a memory of the computing device 250 and/or be accessed by the computing device from a remote computing device or storage system.

It will be appreciated that the trigger point is not necessarily in the same area of the body in which pain is experienced. For example, pain experienced in the vertex of the skull, e.g., as illustrated in FIGS. 7A and 7B may correspond with a trigger point on the splenius capitis muscle in the neck, as illustrated in FIG. 8. While the trigger point in general corresponds to a target location within the treatment area, it is only approximate, the specific location of the target location identified by the massage device 210, for example as described above, may be in a slightly different than indicated, based on a number of anatomical and other factors (e.g., posture, weight bearing, etc.).

The computing device 250 may then display instructions, e.g., via the user interface, on which part of the body the massage device 210 should be placed. The massage device 210 is operated to scan the treatment area and apply a treatment, for example as described above.

According to some examples, the controller may be configured to communicate with an external system, e.g., over the internet, a telephony connection, private network, etc., to transmit information thereto and to receive information therefrom. The information transmitted may include, but is not limited to, data relating to identified target locations, pressure maps, treatments applied, user feedback (e.g., pain rating before and/or after treatment), etc. The information received may be personalized to the patient, thereby facilitating personalized treatment based, e.g., on provided parameters of the patient, including, but not limited to, age, weight, height, sex, pre-existing conditions, medical history, information about previous uses of the device, recommendations, etc.

According to some examples, the external system may analyze data from many users, including feedback, and make one or more recommendations for treatment based on parameters of a patient. According to some examples, a machine leaning model may be trained using the data from many users to provide the recommendations. The recommendations may include, but are not limited to, parameters of the pressure profile for example as described above, rotation speed, lateral distance between projections 20 of the massage head, expected values for pressure detection, use of auxiliary treatment, etc.

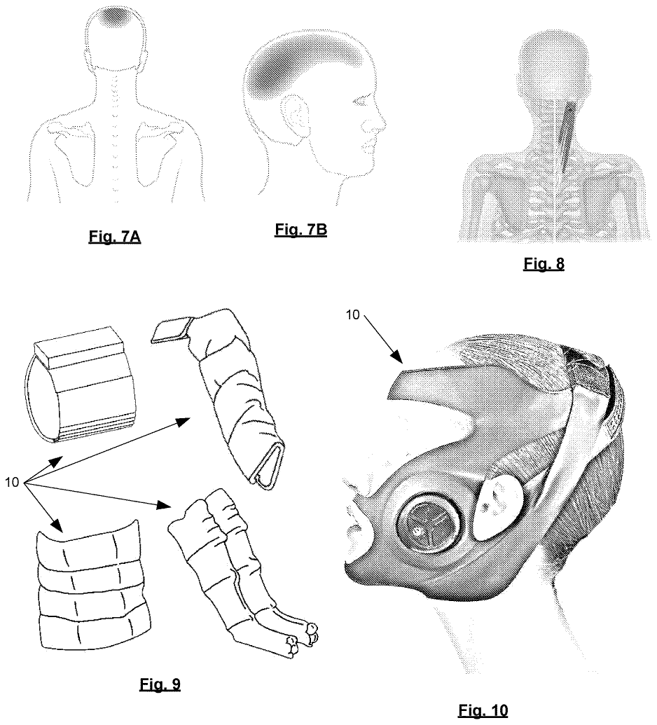

The massage device 10 as described above, including, but not limited to, when constituting part of the system 200 described above with reference to and as illustrated in FIG. 5, may be implemented in any suitable manner. According to some examples, it constitutes part of a substantially planar device which may be secured to the patient before use. According to some examples, it constitutes part of a sleeve, examples of which are illustrated in FIG. 9, which may be secured around a limb and/or a torso of the patient. The massage device 10 may be comprise pockets for receipt therein of a cooling or heating material, for example for compression therapy. A massage device 10 according to these examples may be used, e.g., to treat lateral epicondylalgia, shoulder/upper arm pain, hamstring pain, calf pain, torso pain, etc.

According to some examples, for example as illustrated in FIG. 10, the massage device 10 may be provided as part of a facemask, with functional elements (massage assembly, pressure detection arrangement, etc.) contained therewithin. The massage device 10 according to these examples may be configured, e.g., to apply treatment to the masseter and/or temproalis muscles. According to some examples, it may be used to treat temporomandibular joint disorder.

According to some examples, for example as illustrated in FIG. 11, the massage device 10 may be integrated into a glove, with functional elements (massage assembly, pressure detection arrangement, etc.) contained therewithin. According to some examples, a single pressure detection arrangement is provided. According to some examples, several pressure detection arrangements are provided, e.g., each associated with a different finger of the glove to measure the pressure applied thereto. Each of the several pressure detection arrangements may be configured to measure the pressure applied to a finger independently of that applied to other fingers, or they may be connected. The controller may be housed on a dorsal (i.e., back) side of the glove.

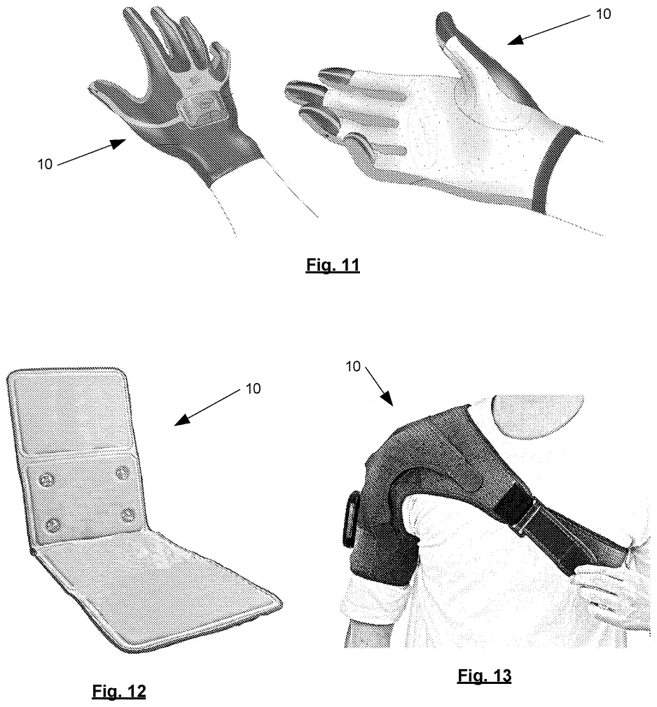

According to some examples, for example as illustrated in FIG. 12, the massage device 10 may constitute part of a chair, a bed, or an apparatus configured to be secured to a chair or a bed, on which the patient sits in or lies on during the therapy. Functional elements thereof (massage assembly, pressure detection arrangement, etc.) are contained therewithin The chair, bed, or apparatus may further comprise a heating and/or a cooling arrangement. According to some examples, it may comprise a vibration arrangement.

According to some examples, for example as illustrated in FIG. 13, the massage device 10 may be integrated into a shoulder compression wrap, with functional elements (massage assembly, pressure detection arrangement, etc.) contained therewithin. According to some examples, a single pressure detection arrangement is provided. According to some examples, several pressure detection arrangements are provided. The shoulder compression wrap may further comprise a heating and/or a cooling arrangement. According to some examples, it may comprise a vibration arrangement.

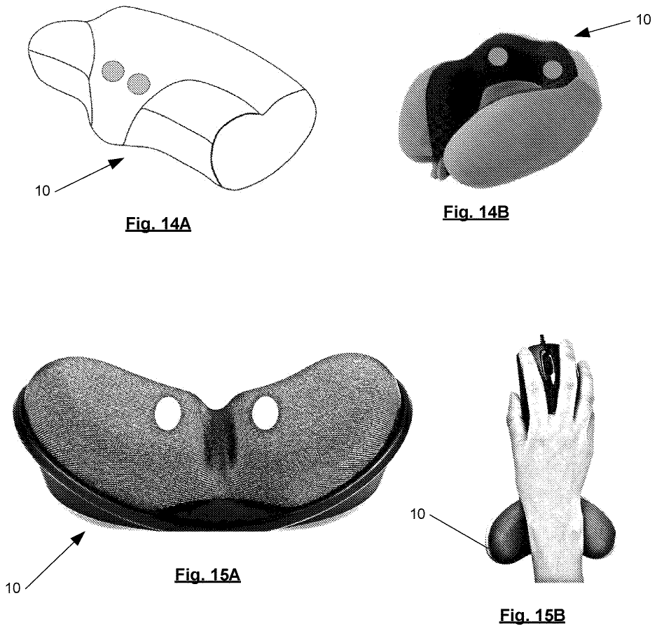

According to some examples, for example as illustrated in FIGS. 14A and 14B, the massage device 10 may be provided as part of a headrest and/or pillow, for example a neck pillow, with functional elements (massage assembly, pressure detection arrangement, etc.) contained therewithin. According to some examples, the massage device 10 may be configured to operate on one or both sides, e.g., comprising massage assemblies 12 facing opposite side thereof. The massage device 10 according to these examples may be useful, e.g., for treatment of headaches, suboccipital headaches, cervicogenic headaches, etc. The headrest and/or pillow may further comprise a heating and/or a cooling arrangement. According to some examples, it may comprise a vibration arrangement.

According to some examples, for example as illustrated in FIGS. 15A and 15B, the massage device 10 may be provided as part of a wrist rest, with functional elements (massage assembly, pressure detection arrangement, etc.) contained therewithin. According to some examples, the massage device 10 may be configured to operate on one or both sides, e.g., comprising massage assemblies 12 facing opposite side thereof. The massage device 10 according to these examples may be useful, e.g., for treatment of repetitive stress injuries and other similar work-related syndromes. The wrist rest may further comprise a heating and/or a cooling arrangement. According to some examples, it may comprise a vibration arrangement.

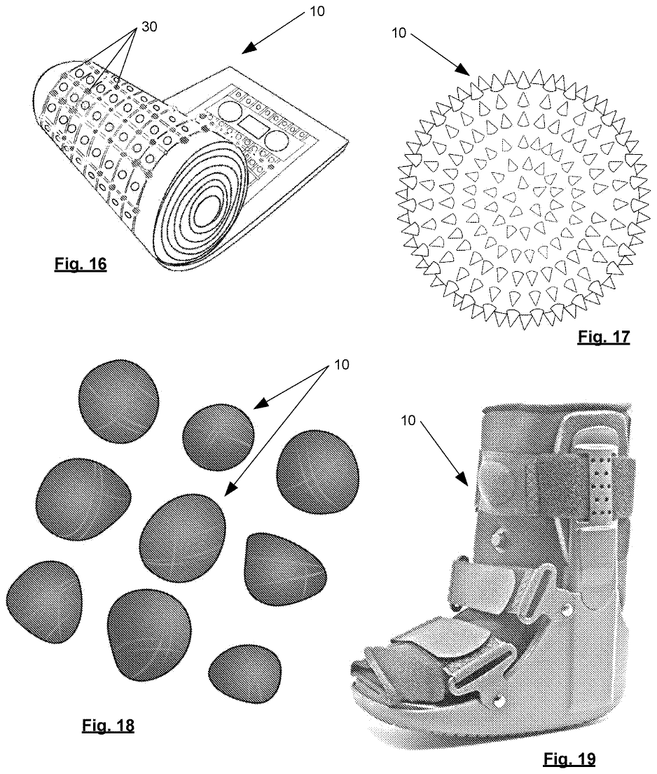

According to some examples, for example as illustrated in FIG. 16, the massage device 10 may be provided as part of a mat, with functional elements (massage assembly, pressure detection arrangement, etc.) contained therewithin. According to some examples, the mat may comprise a plurality of massage assemblies 12 at different location therewithin. The massage device 10 according to these examples may comprise illuminating elements 30 to present information to a user, e.g., related to placement of the device. The massage assemblies 12, individually and/or cooperating with other massage assemblies, may be configured to perform a deep stroking massage. The mat may further comprise a heating and/or a cooling arrangement. According to some examples, it may comprise a vibration arrangement.

According to some examples, for example as illustrated in FIG. 17, the massage device 10 may be provided as part of a ball, for example covered with radially-protruding spikes (as illustrated), with functional elements (massage assembly, pressure detection arrangement, etc.) contained therewithin. The ball may further comprise a heating and/or a cooling arrangement. According to some examples, it may comprise a vibration arrangement. According to some examples, it may further comprise a balancing arrangement, for example comprising one or more gyroscopes, configured to return the ball to a proper orientation when it deviates therefrom.

According to some examples, several examples of which are illustrated in FIG. 18, the massage device 10 may be provided as part of a weighted object, for example simulating small stones, with functional elements (massage assembly, pressure detection arrangement, etc.) contained therewithin. The weighted object may further comprise a heating and/or a cooling arrangement. According to some examples, it may comprise a vibration arrangement. The weighted objects may be configured, e.g., for placement on a patient's back to administer treatment thereto.

According to some examples, for example as illustrated in FIG. 19, the massage device 10 may be integrated into a boot, with functional elements (massage assembly, pressure detection arrangement, etc.) contained therewithin. According to some examples, a single pressure detection arrangement is provided. According to some examples, several pressure detection arrangements are provided. The massage device 10 according to these examples may be useful, e.g., for treatment of Achilles tendinopathy. The boot may further comprise a heating and/or a cooling arrangement. According to some examples, it may comprise a vibration arrangement.

It will be appreciated that the descriptions above with reference to FIGS. 9 through 19 are by way of examples only, and are not meant to be limiting. In particular, features which are described with reference to one or some of the examples are not limited to those examples; rather, they may be optionally included in any of the other examples if suitable, mutatis mutandis, without departing from the scope of the presently disclosed subject matter.

Herein the specification and appended claims, certain terms which are sometimes used in a medical context, such as “patient,” “treatment,” etc., are used. It will be appreciated that these terms are used for convenience only to illustrate and/or define the presently disclosed subject matter, and should not be construed as making any medical or other claims regarding efficacy, nor as limiting the scope of protection to devices and/or procedures which are recognized, recommended, etc., by professional and/or governmental organizations, agencies, etc. Moreover, it will be appreciated that references herein to contact with a patient are not limited to direct contact with the skin, but include instances in which clothing, a protective cover, etc., separate the patient and the massage head without significantly affecting the pressure therebetween, mutatis mutandis.

It will be recognized that examples, embodiments, modifications, options, etc., described herein are to be construed as inclusive and non-limiting, i.e., two or more examples described separately herein are not to be construed as being mutually exclusive of one another or in any other way limiting, unless such is explicitly stated and/or is otherwise clear. Those skilled in the art to which this invention pertains will readily appreciate that numerous changes, variations, and modifications can be made without departing from the scope of the presently disclosed subject matter, mutatis mutandis.

1. A massage device configured to selectively apply pressure at or near one or more target locations within a treatment area of a patient, the device comprising:
a massage assembly comprising:
a massage head configured for selectively applying a pressure at or near the target locations; and
a driving arrangement configured for moving the massage head about the treatment area;
a pressure detection arrangement configured to detect pressure applied to the massage head; and
a controller configured to direct operation of the massage device;
the controller being further configured to:
identify one of the target locations where the pressure detection arrangement detects an elevated pressure applied to the massage head; and
direct the massage head to apply the pressure according to a predetermined pressure profile to the identified target location.

2. The massage device according to claim 1, wherein the pressure detection arrangement comprises a fluid bladder.

3. The massage device according to claim 2, wherein the fluid bladder is disposed proximally to the massage assembly.

4. The massage device according to claim 2, wherein the fluid bladder is filled with a gaseous medium.

5. The massage device according to claim 2, wherein the controller is configured to direct the driving arrangement to move the massage head about the treatment area, and to identify a target location corresponding to the position of the massage head when the internal pressure of the air-pressure increases by a predetermined amount.

6. The massage device according to claim 1, wherein the pressure detection arrangement comprises one or more pressure sensors disposed on the massage assembly.

7. The massage device according to claim 4, wherein the one or more pressure sensors are disposed on the massage head.

8. The massage device according to claim 4, wherein the one or more pressure sensors are configured to measure a force between the massage head and the driving arrangement.

9. The massage device according to any one of the preceding claims, wherein the massage head comprises two or more projections, each configured to apply a pressure at or near the target location.

10. The massage device according to claim 7, wherein the massage head is configured to move the projections.

11. The massage device according to claim 8, wherein the massage head is configured to rotate some or all of the projections about an axis.

12. The massage device according to any one of claims 8 and 9, wherein the massage head is configured to rotate the projections about a common axis.

13. The massage device according to any one of claims 8 through 10, wherein the massage head is configured to move the projections to change the lateral distance between them.

14. The massage device according to any one of claims 8 through 11, wherein the massage head is configured to move at least some of the projections along a distal-proximal axis independently of the other projections.

15. The massage device according to any one of claims 8 through 12, wherein the massage head is configured to move the projections while applying pressure.

16. The massage device according to any one of the preceding claims, wherein the pressure profile comprises a constant pressure for a predetermined amount of time.

17. The massage device according to any one of the preceding claims, wherein the pressure profile comprises a variable pressure for a predetermined amount of time.

18. The massage device according to any one of the preceding claims, being further configured to apply photobiomodulation, ultrasound treatment, vibration, temperature treatment, transcutaneous electrical nerve stimulation, electrical muscle stimulation, and/or shockwave therapy to the patient.

19. The massage device according to any one of the preceding claims, being configured to transmit usage information to an external system.

20. The massage device according to any one of the preceding claims, being configured to receive information comprising treatment recommendations from an outside system.

21-52. (canceled)
